(19) United States
(12) Patent Application Publication
(10) Pub. No.: US 2020/0087482 A1
(43) Pub. Date: Mar. 19, 2020

(54) MOLDED ARTICLE, COMPONENT FOR FOOD PRODUCTION APPARATUS, AND POLYMER PRODUCT FOR FOOD PRODUCTION

(71) Applicants: ARESS TECHNOLOGY CO., LTD., Ibaraki (JP); ARAM CORPORATION, Osaka (JP)

(72) Inventors: Yukihiro YANAGAWA, Ibaraki (JP); Shingo YOSHITOMI, Osaka (JP)

(21) Appl. No.: 16/689,796

(22) Filed: Nov. 20, 2019

Related U.S. Application Data
(63) Continuation of application No. PCT/JP2018/020414, filed on May 28, 2018.

(30) Foreign Application Priority Data
Jun. 5, 2017 (JP) 2017-110584

(51) Int. Cl. C08K 3/08; C08L 21/00

(52) U.S. Cl. CPC C08K 3/08; C08K 2003/0887; C08L 21/00

(57) ABSTRACT

Magnetic material powder that can be detected by a metal detector and the like and tungsten powder that can be detected by an X-ray inspection device are dispersed in a polymer material of the molded article.

### CROSS-REFERENCE TO RELATED APPLICATIONS

This application is a continuation application of International Patent Application No. PCT/JP2018/020414 filed on May 28, 2018, which claims priority to Japanese Patent Application No. 2017-110584 filed on Jun. 5, 2017, the entire contents of which are incorporated by reference.

### TECHNICAL FIELD

The present invention relates to a molded article, a component for a food production apparatus, and a polymer product for food production.

### BACKGROUND ART

Patent Document 1 discloses a molded article formed of rubber or a synthetic resin, the molded article being obtained by mixing, in a dispersed manner, pigments and ferromagnetic stainless steel powder in the rubber or the synthetic resin.

### CITATION LIST

### Patent Document

Patent Document 1: JP 2014-237786 A

Various polymer (rubber, a synthetic resin, and the like) products, such as conveyance belts, packings, cookware, and gloves, are used at a production line that produces and processes food, hence, fragments of these products may be adulterated in food due to degradation or the like of these products. In the invention described in Patent Document 1, ferromagnetic stainless steel powder contained in fragments is detected by a magnet or a metal detector. However, not all fragments can be detected by a magnet or a metal detector.

In recent years, an X-ray inspection device is used to detect foreign objects so that foreign objects can be surely prevented from being adulterated in food. However, there is a problem in that it is impossible to detect ferromagnetic stainless steel powder by an X-ray inspection device.

### SUMMARY OF INVENTION

One or more embodiments of the present invention are directed to a molded article, a component for a food production apparatus, and a polymer product for food production, which make it possible to easily detect fragments of a molded article by a metal detector and an X-ray inspection device.

In one or more embodiments of the present invention, a molded article, a component for a food production apparatus, or a polymer product for food production is formed by, for example, molding a polymer material. This polymer material includes magnetic material powder and tungsten powder that are dispersed therein.

In the molded article according to one or more embodiments of the present invention, the magnetic material powder that can be detected by a metal detector and the like and the tungsten powder that can be detected by an X-ray inspection device are dispersed in the polymer material. Hence, fragments of the molded article can easily be detected by a metal detector and an X-ray inspection device.

Here, the polymer material further includes barium powder dispersed therein. That is, the tungsten powder, which has a higher specific gravity, and the barium powder, which has a lower specific gravity, are mixed and dispersed in the polymer material. With this, occurrence of secondary coagulation can be reduced, and the tungsten powder and the barium powder can be more easily dispersed evenly in the polymer material.

Here, a greater amount of the tungsten powder may be included than the barium powder. With this, an X-ray shielding effect is highly exerted, that is, detection by an X-ray inspection device can be implemented easily.

Here, the polymer material may be rubber, and a ratio of the magnetic material powder with respect to the polymer material may be approximately 28% or less. With this, functions (for example, flexibility, elasticity, an impact absorbing property) intrinsic to rubber can be maintained while containing ferromagnetic stainless steel powder.

In one or more embodiments of the present invention, the molded article may be included in a component for a food production. Further, in one or more embodiments of the present invention, the molded article may be included in a polymer product for food production, which is, for example, a plate-like (plate-shaped) member, an O-ring, a packing, cookware, a glove, or a tying band. With this, fragments that are adulterated in food during production or processing of the food can be detected easily by a metal detector and an X-ray inspection device.

According to one or more embodiments of the present invention, fragments of the molded article can easily be detected by the metal detector and the X-ray inspection device.

### BRIEF DESCRIPTION OF DRAWINGS

FIG. 1 is a view illustrating one example of a conveyor apparatus 1 formed of a plate-like member to which a molded article according to the present invention is applied.

FIG. 2 is a view schematically illustrating a cross section of a belt 11.

FIGS. 3A and 3B are views schematically illustrating one example of an O-ring 2, which is a component for a food production apparatus to which the molded article according to the present invention is applied. FIG. 3A is a plan view, and FIG. 3B is a sectional view taken along the line D-D of FIG. 3A.

FIGS. 4A and 4B are views schematically illustrating one example of a spatula 3, which is a polymer product for food production to which the molded article according to the present invention is applied. FIG. 4A is a perspective view, and FIG. 4B is a sectional view taken along the line E-E of FIG. 4A.

FIG. 5 is a graph showing results of X-ray radiation to test pieces obtained from a molded article, for each of Samples 1 to 5.

FIG. 6 is a graph showing results of X-ray radiation to test pieces obtained from a molded article while changing a content amount of tungsten powder in a case where only the tungsten powder is mixed in silicone rubber.

### DESCRIPTION OF EMBODIMENTS

Now, with reference to the drawings, detailed description is made on one or more embodiments of the present invention. A molded article according to the present embodiment is obtained by molding a polymer material, and the polymer material includes magnetic material powder and X-ray shielding powder (tungsten powder and barium powder in the present embodiment) that are dispersed therein.

The molded article is applicable to a component for a food production apparatus and a polymer product for food production. The component for a food production apparatus and the polymer product for food production are not particularly limited, and may be, for example, a plate-like member, an O-ring, a packing, cookware, a glove, or a tying band.

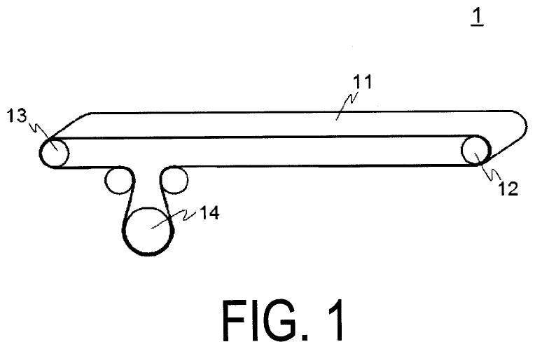

FIG. 1 is a view illustrating one example of a conveyor apparatus 1 formed of a plate-like member to which a molded article according to the present invention is applied. The conveyor apparatus 1 is a food production apparatus used for the purpose of conveying small objects, such as food and medicine, and the plate-like member is used as a belt 11, which is a component of the conveyor apparatus 1.

The conveyor apparatus 1 mainly includes: a head pulley 12 and a tail pulley 13 that are provided at a leading end and a trailing end of a conveyor frame (not shown), respectively; the belt 11 that is stretched between the head pulley 12 and the tail pulley 13; and a drive pulley 14 that is rotationally driven by a drive source (not illustrated). When the drive pulley 14 is rotationally driven, the belt 11 is circularly driven between the head pulley 12 and the tail pulley 13.

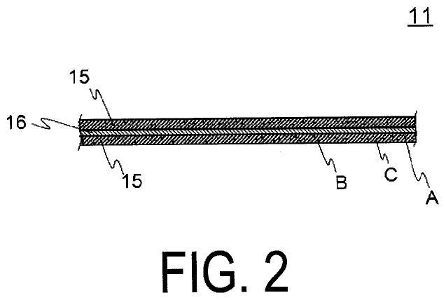

FIG. 2 is a view schematically illustrating a cross section of the belt 11. FIG. 2 illustrates the belt 11 cut along a direction substantially orthogonal to a longitudinal direction thereof. Moreover, FIG. 2 illustrates an enlarged view for the sake of description. The belt 11 has a configuration in which a wire net 16, which is formed by weaving metal linear materials, is interpose between plate-like members 15 formed of the molded article according to the present invention. Note that, an item interposed between the plate-like members 15 is not limited to the wire net 16.

Note that, the plate-like member to which the molded article according to the present invention is applied may be used not only as the belt 11 but also as a partition or the like provided in the vicinity of, for example, a food production machine.

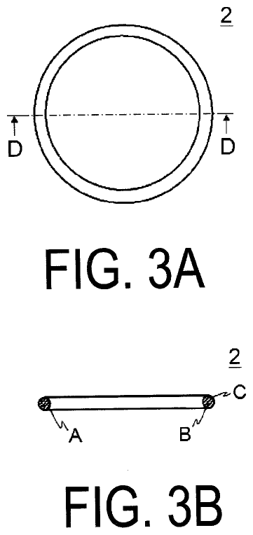

FIG. 3 are views schematically illustrating one example of an O-ring 2, which is a component for a food production apparatus to which the molded article according to the present invention is applied. FIG. 3A is a plan view, and FIG. 3B is a sectional view taken along the line D-D of FIG. 3A. The entire O-ring 2 is formed of only the molded article according to the present invention.

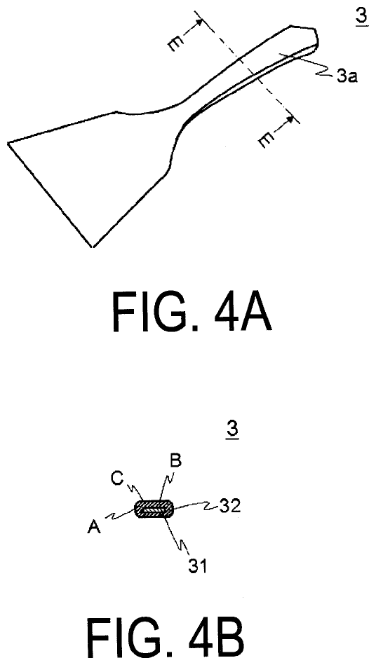

FIG. 4 are views schematically illustrating one example of a spatula 3, which is a polymer product for food production to which the molded article according to the present invention is applied. FIG. 4A is a perspective view, and FIG. 4B is a sectional view taken along the line E-E of FIG. 4A. A grip 3a of the spatula 3 has a configuration in which a metal core 31 thereof is covered with a molded portion 32 formed of the molded article according to the present invention. However, the core 31 is not limited to metal, and a high-strength resin (for example, high-strength nylon) may be used. Note that the spatula 3 is one example of cookware, and the cookware also includes a scraper, a brush, and the like.

As described above, the component for a food production apparatus and the polymer product for food production may be entirely formed of the molded article according to the present invention, or at least a part thereof may be formed of the molded article according to the present invention.

Note that the molded article according to the present invention is applicable to components, tools, clothes, and the like that are used in a food processing plant. The “food processing plant” includes a plant that deals with food in general, i.e., not only a plant that processes and cooks food but also a plant that merely sorts out or packages food. Moreover, in the present invention, the “food” includes supplements, vitamin tablets, and the like. Further, the molded article according to the present invention is applicable to a component for a medicine production apparatus and a polymer product for medicine production.

As schematically illustrated in FIG. 2, FIG. 3B, and FIG. 4B, the molded article according to the present invention includes magnetic material powder B and X-ray shielding powder C that are evenly dispersed in a polymer material A. Detailed description on the molded article is provided below.

Examples of the polymer material include a thermoplastic resin, a thermosetting resin, an elastomer, an elastic material (rubber), and the like. One kind of those polymer materials may be used alone, or two or more kinds of those polymer materials may be used in combination.

Examples of the thermoplastic resin include polyethylene terephthalate (PET), polycarbonate (PC), an acrylonitrile butadiene styrene copolymer resin (ABS), polyethylene (PE), polyvinyl chloride (PVC), polypropylene (PP), polytetrafluoroethylene (PTFE), an aramid resin, and an elastomer. Examples of the thermosetting resin include an epoxy resin. Examples of the rubber include urethane rubber, silicone rubber, ethylene propylene rubber (EPDM), nitrile rubber (NBR), styrene butadiene rubber (SBR), and natural rubber (NR). Note that urethane rubber and silicone rubber can be continuously molded, and hence are preferably used.

Next, description on the magnetic material powder is provided. The magnetic material powder is mixed in the polymer material so that, when fragments of the molded article or the like are adulterated in food, the fragments can be detected by a metal detector and an X-ray inspection device.

Examples of the magnetic material powder include ferromagnetic stainless steel powder, triiron tetraoxide (Fe₃O₄), and Fe₈Cr. The ferromagnetic stainless steel powder is stainless steel powder having a magnetization force, i.e., generally martensitic or ferritic stainless steel powder. In the present embodiment, SUS410L, which is ferritic stainless steel, is used.

A ratio of the ferromagnetic stainless steel powder is not particularly limited as long as, for instance, strength of the molded article is ensured and detection with a metal detector and an X-ray inspection device can be implemented. For example, when rubber is used as the polymer material, the ratio of the ferromagnetic stainless steel powder is preferably approximately 28 mass % or less in order to secure functions (for example, flexibility, elasticity, an impact absorbing property) intrinsic to rubber while containing the ferromagnetic stainless steel powder.

The ferromagnetic stainless steel powder preferably has a substantially spherical shape and a particle diameter from 0.5 μm to 25 μm to disperse the ferromagnetic stainless steel powder evenly in the polymer material.

Next, description on the X-ray shielding powder (tungsten powder and barium powder) is provided. The X-ray shielding powder is mixed in the polymer material so that, when fragments of the molded article or the like are adulterated in food, the fragments can be detected by an X-ray inspection device.

A ratio of the X-ray shielding powder is preferably approximately 10 mass % or less. For example, approximately 5 mass % of tungsten powder and approximately 5 mass % of barium powder may be mixed to obtain the X-ray shielding powder. Note that preferably more tungsten powder is included than barium powder in the X-ray shielding powder (described later in detail), and approximately 90% of the X-ray shielding powder may be tungsten powder. Most suitably, the X-ray shielding powder is mixed with approximately 9 mass % of the tungsten powder and approximately 1 mass % of the barium powder.

The X-ray shielding powder preferably has a particle diameter from 0.1 μm to 10 μm so as to disperse the ferromagnetic stainless steel powder evenly in the polymer material. Particularly, the X-ray shielding powder has a particle diameter of approximately 4.0 μm, whereby the X-ray shielding powder can be dispersed evenly in the polymer material.

Note that the molded article, the component for a food production apparatus, and the polymer product for food production according to the present invention can be produced by various methods, such as injection molding, UV curable resin molding, and thermosetting resin molding. However, the production is preferably performed by extrusion molding, which is advantageous for orientation of the polymer material and dispersion of the magnetic material powder and the X-ray shielding powder.

Specific description on an effect exerted by the X-ray shielding powder is provided. Note that materials, blending ratios, production methods, and the like described below are not limited thereto.

### Sample 1

With silicone rubber being used as the polymer material, a molding material was produced by mixing tungsten powder and barium powder in the silicone rubber. In other words, in Sample 1, tungsten powder and barium powder were used as X-ray shielding powder. A blending ratio in Sample 1 was as follows: approximately 95 mass % of silicone rubber, approximately 1.5 mass % of tungsten powder, and approximately 3.5 mass % of barium powder.

The molded article was produced by extrusion molding, in which molding material was melted and fluidized in a heating cylinder of an extruding machine, the molding material in the heating cylinder was caused to advance continuously by a screw and was continuously extruded through a mouthpiece by rotation of the screw and an inner pressure.

### Sample 2

A blending ratio of tungsten powder and barium powder was different from that in Sample 1. A blending ratio in Sample 2 was as follows: approximately 95 mass % of silicone rubber, approximately 2.5 mass % of tungsten powder, and approximately 2.5 mass % of barium powder.

### Sample 3

A blending ratio of tungsten powder and barium powder was different from that in Sample 1. A blending ratio in Sample 3 was as follows: approximately 95 mass % of silicone rubber, approximately 3.5 mass % of tungsten powder, and approximately 1.5 mass % of barium powder.

### Sample 4

A kind of powder to be mixed in silicone rubber and a blending ratio thereof were different from those in Sample 1. In Sample 4, only tungsten powder was used as X-ray shielding powder (barium powder was not used).

In Sample 4, a molding material was produced by mixing tungsten powder in silicone rubber. A blending ratio in Sample 4 was as follows: approximately 95 mass % of silicone rubber and approximately 5 mass % of tungsten powder.

### Sample 5

A kind of powder to be mixed in silicone rubber and a blending ratio thereof were different from those in Sample 1. In Sample 5, only barium powder was used as X-ray shielding powder (tungsten powder was not used).

In Sample 5, a molding material was produced by mixing only barium powder in silicone rubber. A blending ratio in Sample 5 was as follows: approximately 95 mass % of silicone rubber and approximately 5 mass % of barium powder.

### Evaluation on X-ray Shielding Effect

Test pieces were obtained by forming each of the molded articles thus obtained into a substantially spherical shape (here, a spherical shape having a diameter of approximately 3 mm). The test pieces were adhered to a belt inside an X-ray inspection device, and results of X-ray radiation to the test pieces were measured.

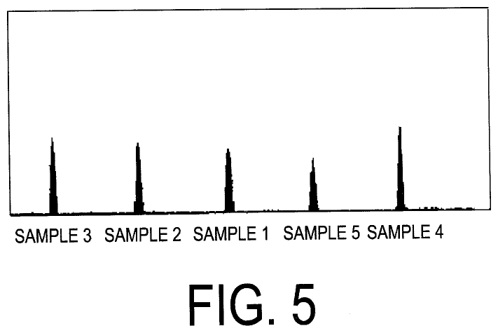

FIG. 5 is a graph showing results of X-ray radiation to the test pieces obtained from the molded article, for each of Samples 1 to 5. In FIG. 5, a higher bar in the graph indicates a higher X-ray shielding effect.

Sample 4 obtained by mixing only tungsten powder in silicone rubber exhibited the highest X-ray shielding effect, and Sample 5 obtained by mixing only barium powder in silicone rubber exhibited the lowest X-ray shielding effect. Thus, it has been found out that at least tungsten powder has to be mixed as the X-ray shielding powder in the polymer material as in Samples 1 to 4.

Samples 1 to 3 obtained by mixing tungsten powder and barium powder in silicone rubber exhibited a higher X-ray shielding effect as a content ratio of tungsten powder was increased, in other words, as an amount of tungsten powder was increased.

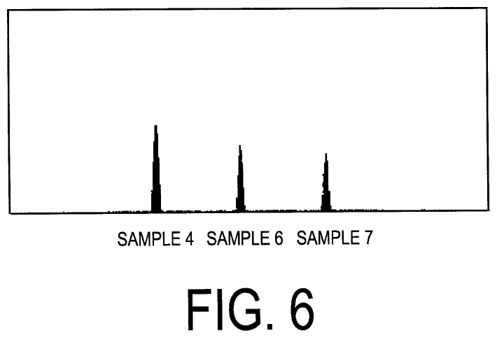

FIG. 6 is a graph showing results of X-ray radiation to the test pieces obtained from the molded article while changing a content amount of tungsten powder in a case where only the tungsten powder was mixed in silicone rubber. A blending ratio in Sample 6 was as follows: approximately 97 mass % of silicone rubber and approximately 3 mass % of tungsten powder. A blending ratio in Sample 7 was as follows: approximately 98 mass % of silicone rubber and approximately 2 mass % of tungsten powder. From these results, it has been found out that a higher X-ray shielding effect is exhibited as an amount of tungsten powder is increased.

Table 1 shows results of detection performed using an X-ray inspection device and a metal detector on test pieces obtained from molded articles in a case where X-ray shielding powder and magnetic material powder are mixed in silicone rubber. As the X-ray shielding powder, tungsten powder (in this case, tungsten oxide (WO₃)) and barium powder were used, and Fe8Cr was used as the magnetic material powder. The test pieces were obtained by forming each of the obtained molded articles into a substantially spherical shape, and the test pieces were adhered to a belt inside an X-ray inspection device and a metal detector to implement detection. Amounts of WO₃, barium, and Fe8Cr contained in each of samples 8 to 13 were different from sample to sample.

The results shown in Table 1 were merely examples. The detection results may differ depending on measurement conditions and measurement devices. Yet, it has been found out that detection by an X-ray inspection device and a metal detector is more easily performed as the content amounts of the X-ray shielding powder and the magnetic material powder are larger. In order to detect fragments of the molded article by a metal detector or an X-ray inspection device, preferably the ratio of the X-ray shielding powder and the ratio of the magnetic material powder are approximately 5 mass % or greater. Particularly, the ratio of the X-ray shielding powder is preferably approximately 10 mass %. The ratio of the magnetic material powder is preferably approximately 20 mass % or greater.

TABLE 1

| | | Tungsten | | | Test piece | X-ray inspection | | Metal detection | |
|---|---|---|---|---|---|---|---|---|---|
| | Polymer | oxide | Barium | | particle | result | | result | |
| | material | powder | powder | Fe8Cr | diameter | Belt speed at | Belt speed at | Belt speed at | Belt speed at |
| | (mass %) | (mass %) | (mass %) | (mass %) | (mm) | 30 m/min | 20 m/min | 40 m/min | 20 m/min |
| Sample 8 | 95.0% | 2.0% | 0.5% | 2.5% | 1 | Not detected | Not detected | Not detected | Not detected |
| | | | | | 2 | Not detected | Not detected | Not detected | Not detected |
| | | | | | 3 | Not detected | Not detected | Not detected | Not detected |
| Sample 9 | 90.0% | 4.0% | 1.0% | 5.0% | 1 | Not detected | Not detected | Not detected | Not detected |
| | | | | | 2 | Not detected | Detected | Not detected | Not detected |
| | | | | | 3 | Not detected | Detected | Not detected | Not detected |
| Sample 10 | 80.0% | 8.0% | 2.0% | 10.0% | 1 | Detected | Detected | Not detected | Detected |
| | | | | | 2 | Detected | Detected | Not detected | Detected |
| | | | | | 3 | Detected | Detected | Not detected | Detected |
| Sample 11 | 75.0% | 8.0% | 2.0% | 15.0% | 1 | Detected | Detected | Not detected | Detected |
| | | | | | 2 | Detected | Detected | Not detected | Detected |
| | | | | | 3 | Detected | Detected | Not detected | Detected |
| Sample 12 | 70.0% | 8.0% | 2.0% | 20.0% | 1 | Detected | Detected | Detected | Detected |
| | | | | | 2 | Detected | Detected | Detected | Detected |
| | | | | | 3 | Detected | Detected | Detected | Detected |
| Sample 13 | 65.0% | 8.0% | 2.0% | 25.0% | 1 | Detected | Detected | Detected | Detected |
| | | | | | 2 | Detected | Detected | Detected | Detected |
| | | | | | 3 | Detected | Detected | Detected | Detected |

As described already, in consideration of only the easier detection by an X-ray inspection device, it is preferable to increase a ratio of tungsten powder in the X-ray shielding powder as much as possible, hence, as the X-ray shielding powder, only the tungsten powder may be mixed in the polymer material. However, note that with the X-ray shielding powder being mixed with the tungsten powder and the barium powder, the X-ray shielding powder can be dispersed evenly in the polymer material.

For example, when only the tungsten powder is dispersed in the polymer material, secondary coagulation, in which particles of tungsten powder are bounded with each other, is liable to occur, hence, the tungsten powder may not be dispersed evenly in the polymer material. In contrast, by mixing tungsten powder, which has a higher specific gravity, and barium powder, which has a lower specific gravity, with each other, occurrence of secondary coagulation is reduced, and the tungsten powder and the barium powder are more easily dispersed evenly in the polymer material.

According to the present embodiment, the magnetic material powder and the X-ray shielding powder are dispersed in the molded article. Thus, even when fragments of the molded article are unintentionally adulterated in food or the like, the fragments can be detected easily by a metal detector and an X-ray inspection device. Since the metal detector and X-ray inspection device are widely used for food inspection, with no need to add a special inspection step, it becomes possible to detect fragments of the molded article.

In particular, since food is directly placed on the belt 11 of the conveyor apparatus 1, which is a component for a food production apparatus, fragments thereof are liable to be adulterated in the food. Moreover, cookware or gloves, which are polymer products for food production, have a direct contact with food, hence fragments thereof are liable to adhere to the food. Therefore, by configuring these products using the molded article obtained by dispersing magnetic material powder and X-ray shielding powder in polymer material, it becomes easier to detect fragments adulterated in food.

Note that, in the present embodiment, the magnetic material powder and the X-ray shielding powder (tungsten powder and barium powder) have a substantially spherical shape. However, the shape of the magnetic material powder and the X-ray shielding powder is not limited to a substantially spherical shape. The magnetic material powder and the X-ray shielding powder may have strong anisotropy, and may have, for example, bar-shaped particles or a fibrous shape. When the magnetic material powder and the X-ray shielding powder have a fibrous shape, the diameter is preferably from approximately 300 nm to approximately 50 μm. Moreover, the magnetic material powder may have a substantially spherical shape, the X-ray shielding powder may have a fibrous shape, the magnetic material powder may have a fibrous shape, and the X-ray shielding powder may have a substantially spherical shape. By mixing powder having a fibrous shape in powder having a substantially spherical shape, it becomes easier to detect fragments adulterated in food.

The embodiments of the invention are described above in detail with reference to the drawings. Specific configurations are not limited to the embodiments and also include changes in the design or the like within a scope that does not depart from the gist of the invention. Further, the term “substantially” in the present invention is a concept not only including the case of being strictly the same, but also including deviations and modifications to an extent that does not result in loss in identity.

### REFERENCE SIGNS LIST

1 Conveyor apparatus
2 O-ring
3 Spatula
3a Grip
11 Belt
12 Head pulley
13 Tail pulley
14 Drive pulley
15 Plate-like member
16 Wire net
31 Core
32 Molded portion
A Polymer material
B Magnetic material powder
C X-ray shielding powder

1. A molded article formed from a polymer material,
the polymer material including magnetic material powder and tungsten powder that are dispersed therein.

2. The molded article according to claim 1, wherein the polymer material further includes barium powder dispersed therein.

3. The molded article according to claim 2, wherein a greater amount of the tungsten powder is included than the barium powder.

4. The molded article according to claim 1, wherein
the polymer material is rubber, and
a ratio of the magnetic material powder with respect to the polymer material is 28 mass % or less.

5. A component for a food production apparatus, at least a part of which comprises the molded article of claim 1.

6. A polymer product for food production, which is a plate-shaped member, an O-ring, a packing, cookware, a glove, or a tying band, and at least a part of which comprises the molded article of claim 1.

7. The molded article according to claim 2, wherein
the polymer material is rubber, and
a ratio of the magnetic material powder with respect to the polymer material is 28 mass % or less.

8. The molded article according to claim 3, wherein
the polymer material is rubber, and
a ratio of the magnetic material powder with respect to the polymer material is 28 mass % or less.

9. A component for a food production apparatus, at least a part of which comprises the molded article of claim 2.

10. A component for a food production apparatus, at least a part of which comprises the molded article of claim 3.

11. A component for a food production apparatus, at least a part of which comprises the molded article of claim 4.

12. A polymer product for food production, which is a plate-shaped member, an O-ring, a packing, cookware, a glove, or a tying band, and at least a part of which comprises the molded article of claim 2.

13. A polymer product for food production, which is a plate-shaped member, an O-ring, a packing, cookware, a glove, or a tying band, and at least a part of which comprises the molded article of claim 3.

14. A polymer product for food production, which is a plate-shaped member, an O-ring, a packing, cookware, a glove, or a tying band, and at least a part of which comprises the molded article of claim 4.
